(19) United States
(12) Patent Application Publication
(10) Pub. No.: US 2021/0300104 A1
(43) Pub. Date: Sep. 30, 2021

(54) BOOK CHARACTER DEVICE STRUCTURE

(71) Applicant: Isaac Ost, Scottsdale, AZ (US)

(72) Inventor: Isaac Ost, Scottsdale, AZ (US)

(21) Appl. No.: 17/214,179

(22) Filed: Mar. 26, 2021

Related U.S. Application Data
(60) Provisional application No. 63/001,433, filed on Mar. 29, 2020.

(51) Int. Cl. B42D 5/00; A63H 3/00; A63H 3/10

(52) U.S. Cl. CPC B42D 5/006; A63H 3/10; A63H 3/003

(57) ABSTRACT

A book device structure for any and all book devices wherein one or more first attachments are operatively connected to either the front cover, back cover, or one or more internal pages, such that the attachments are functional and may be engaged with by a user of the device. The first attachments resemble a human or nonhuman leg or arm, such that the collective book device structure takes the form of a human or nonhuman character, figure, or individual. When applied to a written, printed, fillable, or blank literary or graphic work, whether published or not, the addition of one or more of these functional attachments to the book device produces unique functionality and a structure that resembles what is referred to as a “Book Character” device structure.

### CROSS REFERENCE

This application claims priority to U.S. Provisional Patent Application No. 63/001,433 filed Mar. 29, 2020, the specifications of which are incorporated herein in their entirety by reference.

### FIELD OF THE INVENTION

The present invention relates to a new device structure for any and all classes of written, printed, published, blank, and fillable books, booklets, notebooks, journals, magazines, and any other non-digital literary or graphic works (e.g. blank hardcover and paperback books, educational writing booklets, coloring books, sketchbooks, fillable workbooks, comic books, etc.). The “Book Character” device structure includes at least one first attachment that takes the form of a functional “leg” or “arm” such that the book device resembles a human or nonhuman character, individual, or figure. The Book Character device structure has several purposes, but most notably, this structure facilitates further interaction and engagement between the reader/viewer and the book device itself. For example, the user may engage with the book device as a playable figure, similar to a toy or action figure, as the first attachment is functional and may be manipulated by the user.

For published literary and graphic works, the Book Character device structure may also further inform the viewer/reader about the author, narrator, nature of the content, or source of the information that is being made available within the work. This may be accomplished through adapting the shape and design of the Book Character device structure such that it communicates this further information (e.g. the Book Character device is shaped as a human figure and designed in the appearance of a historical individual so as to communicate that the work has to do with this individual).

For blank, finable, and unpublished works, the Book Character device structure allows creators/authors to approach the creation of their content through a unique perspective that positively influences the material being generated. By imagining oneself or another individual as the book device, itself, it promotes more creativity and leads to a more fun and relevant learning experience. Research shows that when learning is fun and relevant, it results in improved information processing in the brain and better long-term memory storage (Thanos et al., 1999; Chugani, 1998; Pawlak, Magarinos, Melchor, McEwan, & Strickland, 2003).

### BACKGROUND OF THE INVENTION

The preferred embodiment of the present invention is made available under the Buddy the Book® Brand and is used by individuals to assist in the creation of illustrated literary and graphic works. The Story Booklet, as the preferred embodiment is called, is not the only embodiment of the present invention, but is one existing embodiment that can be used to reflect the utility that comes from this book device structure.

The Story Booklet is a blank, fillable writing booklet that includes a front cover, back cover, and one or more internal pages. There are two functional arms and two nonfunctional legs attached to the back cover of this booklet to create a Book Character device structure. The arms consist of a forearm and bicep section, which are attached with eyelets. Together, this arm is attached to the back cover with eyelets to facilitate the full rotation of these attached components. As such, the two functional arms are considered the first attachments. Nonfunctional legs are included in this embodiment. They are not attached with an eyelet or other attachment mechanism that facilitates any functionality, and as such may be considered the second attachment of this embodiment of the present invention.

The utility of the Book Character device structure in relation to the preferred embodiment (Story Booklet) is that it assists the author in generating content for their literary or graphic work, while at the same time facilitating improved communication and engagement with their readers/viewers. In other words, imagining oneself or another individual as a book and creating a literary or graphic work through this perspective promotes more creativity and leads to unique and beneficial outcomes for both the creator and viewer when compared to traditional content creation approaches.

Furthermore, the completed Story Booklet allows the reader/viewer to understand additional information about the collective work through its appearance and structure, alone. For example, a writer can imagine a historical figure as a book, design the Story Booklet to look like this individual, and write an informative essay within the pages of the Story Booklet. The Book Character device structure, along with the design and/or language that the creator/author added results in a viewer/reader immediately understanding that the content within has some relation to that historical figure (i.e. it is written through that figure's point of view, the figure is a central character in the content, or it is of a subject matter that is directly related to that figure, etc.). The viewer/reader may also engage with the Story Booklet as if it were a toy or figure to play with. This added engagement is important in increasing the effectiveness of certain educational strategies.

The methodology of imagining oneself or another individual as the device that is being used to make content available to the viewer/reader can be applied to any of the previously mentioned works or devices, such as imagining oneself or another as a hardcover book, magazine, comic book, etc. This is applicable for both authors/creators that are making their own published literary or graphic work for an audience, as well as authors/creators that are using a manufactured device that is designed to allow them to populate their own content within (e.g. Story Booklet, sketchbook, coloring book, notebook, etc.)

Another example involves an author/creator of a published work that is sold and distributed in the marketplace. A traditional literary or graphic work may be manufactured in the Book Character device structure and may have that author/creator's content printed within it before distribution. One instance of this case can involve, but is not limited to, the creator of a comic book series. This creator may want to add arms and legs to the comic book to provide a Book Character device structure and add a complementary design so that the collective work physically resembles an unknown character that will be introduced. This would serve a similar educational purpose, which is to communicate further information about the nature of the content within the literary or graphic work. It can also provide further ways for the audience to physically interact with the comic book, such as engaging with a movable component like arm, weapon, cape, etc. The content within that specific work may also have a direct correlation to the individual that is visually represented through the Book Character device structure.

### SUMMARY OF THE INVENTION

Various embodiments of a book device structure (100) for any and all classes of written, printed, published, blank, and fillable books, booklets, notebooks, journals, magazines, and any other non-digital literary or graphic works (e.g. blank hardcover and paperback books, educational writing booklets, coloring books, sketchbooks, fillable workbooks, comic books, etc.).

The book device structure (100) includes a front cover (110) comprising a first top surface (111), and a first bottom surface (112) opposite the first top surface; a back cover (120) comprising a second top surface (121), and a second bottom surface (122) opposite the second top surface; one or more internal pages (130) comprising a third top surface (131), and a third bottom surface (132) opposite the third top surface; a binding component (140) used to combine the front cover (110), back cover (120), and any internal pages (130) into one book device structure (100), the binding component (140) is attached on the first side (141) or the opposite side (142) or the top side (143) or the bottom side (144) of the front cover, back cover, and internal pages such that these components connect into one device, the binding component (140) may be of a coil (310), sewn (320), wire (330), saddle-stitched (340), comb (350), tape (360), vela (370), or perfect (380) binding configuration, among others; one or more first attachments (150) operatively connected (151) to the first top surface (111) or first bottom surface (112) of the front cover (110) or the second top surface (121) or second bottom surface (122) of the back cover (120) or the third top surface (131) or third bottom surface (132) of one or more internal pages (130), the first attachment comprises one or more individual components (152) adapted to function as and resemble a leg or arm or a similar feature such as a tentacle (410), wheel (420), or wing (430); wherein the book device structure (100) is configured such that the first attachment (150) may be engaged with by a user and the device as a whole resembles a character, individual, or figure, whether real or imagined (200).

One or more second attachments (160) may be operatively connected or nonoperatively connected to or combined with the first top surface (111) or first bottom surface (112) of the front cover (110) or the second top surface (121) or second bottom surface (122) of the back cover (120) or the third top surface (131) or third bottom surface (132) of one or more internal pages (130), the second attachment (160) comprises one or more individual components adapted to function as and resemble a leg or arm.

One or more third attachments (500) may be operatively connected or nonoperatively connected to or combined with the first top surface (111) or first bottom surface (112) of the front cover (110) or the second top surface (121) or second bottom surface (122) of the back cover (120) or the third top surface (131) or third bottom surface (132) of one or more internal pages (130), the third attachment (500) comprises one or more components adapted to resemble the function and appearance of an accessory (510), such as apparel, equipment, and other character features.

The first attachment (150) second attachment (160) and third attachment (500) may be attachable and detachable (640), and may be able to be manipulated, such as rotated (610), extended (620), and contracted (630). A simple example of this would be a human shaped arm that includes a separate forearm (153) and bicep (154), which would be attached in a manner to facilitate the rotation (610) or movement of the arm component. The entire arm may or may not be attachable and detachable (640) from the main book device body. The present invention is not limited to just these examples alone.

The material used to create the book device structure (100) as well as any attachments (150) (160) (500) can be anything that would be used to serve the purpose of creating such a device. This includes materials like paper, plastic, silicon, cloth, and other organic and inorganic materials that are suitable to create such a book device with added attachments.

### BRIEF DESCRIPTION OF THE DRAWINGS

The patent application or application file contains at least one drawing executed in color. Copies of this patent or patent application publication with color drawing(s) will be provided by the Office upon request and payment of the necessary fee. The features and advantages of the present invention will become apparent from a consideration of the following detailed description presented in connection with the accompanying drawings in which:

FIG. 1 shows a perspective view of the front of the book device structure along with a perspective view of the first attachment. The various sides where binding may be applied to is also shown.

FIG. 2 shows a perspective view of the internal pages of the book device structure of FIG. 1.

FIG. 3 shows a perspective view of the back cover of the book device structure of FIG. 1.

FIG. 4 shows four fully designed examples of the preferred embodiment of the book device structure of FIG. 1.

FIG. 5 shows various binding components that may be used to combine the front cover, back cover, and any internal pages of the book device structure of FIG. 1.

FIG. 6 shows examples of a second attachment of the book device structure of FIG. 1. The second attachment comprises one or more “leg-like” or “arm-like” components. These components serve a similar purpose as a typical “leg” and “arm” and, in some embodiments of the present invention, may additionally be considered as the first attachment of the book device structure of FIG. 1.

FIG. 7 shows examples of a third attachment of the book device structure of FIG. 1. The third attachment comprises one or more components adapted to resemble the function and appearance of an accessory, such as apparel, equipment, and other character features that are not a “leg” or “arm”.

FIG. 8 shows examples of ways in which the first attachment of the book device structure of FIG. 1 may be structured to facilitate different forms of manipulation such as, but not limited to, rotation, extension, contraction, detachment and attachment.

FIG. 9 shows a drawing of one embodiment of the present invention that is adapted for a traditional hardcover book structure. The first, second, and third attachments are added to the back cover of the hardcover book.

FIG. 10 shows a drawing of one embodiment of the present invention wherein at least one of its internal pages have a first attachment such that the internal page resembles and functions as a “Book Character”. You can see that the book is opened to an internal page, and this page has a full page illustration showing an individual, along with text above.

FIG. 11 shows pictures of the physical Story Booklet, which is one of the preferred embodiments of the present invention. The front cover and internal pages are shown in these pictures.

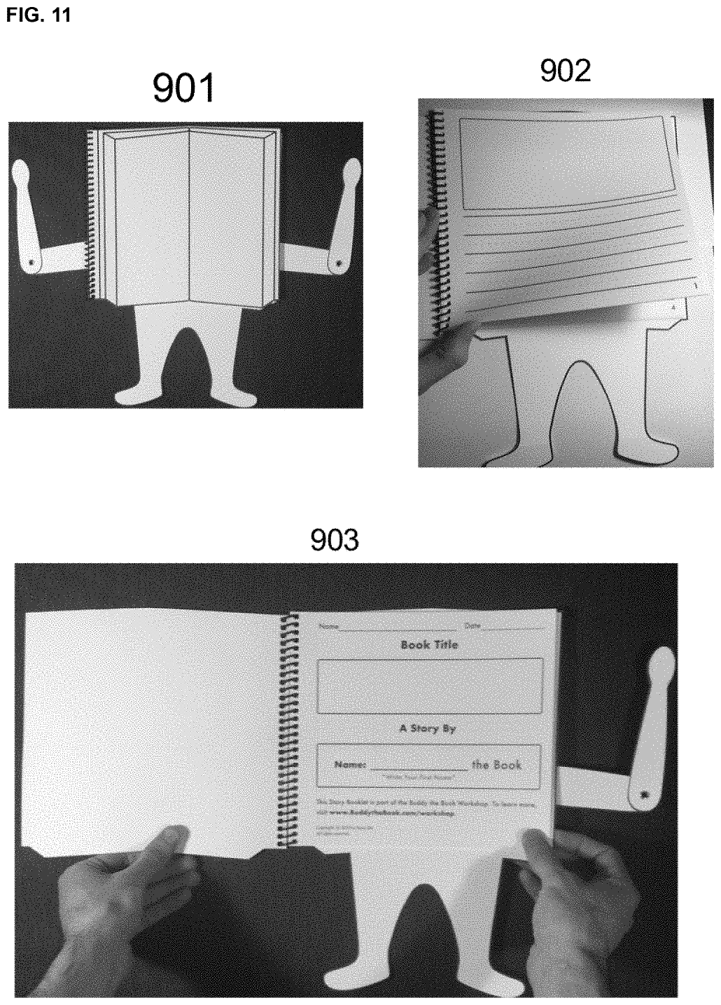

FIG. 12 shows additional pictures of the physical Story Booklet, which is one of the preferred embodiments of the present invention. The internal pages being flipped along with both surfaces of the back cover are shown. The first attachments are operatively connected to the back cover as shown.

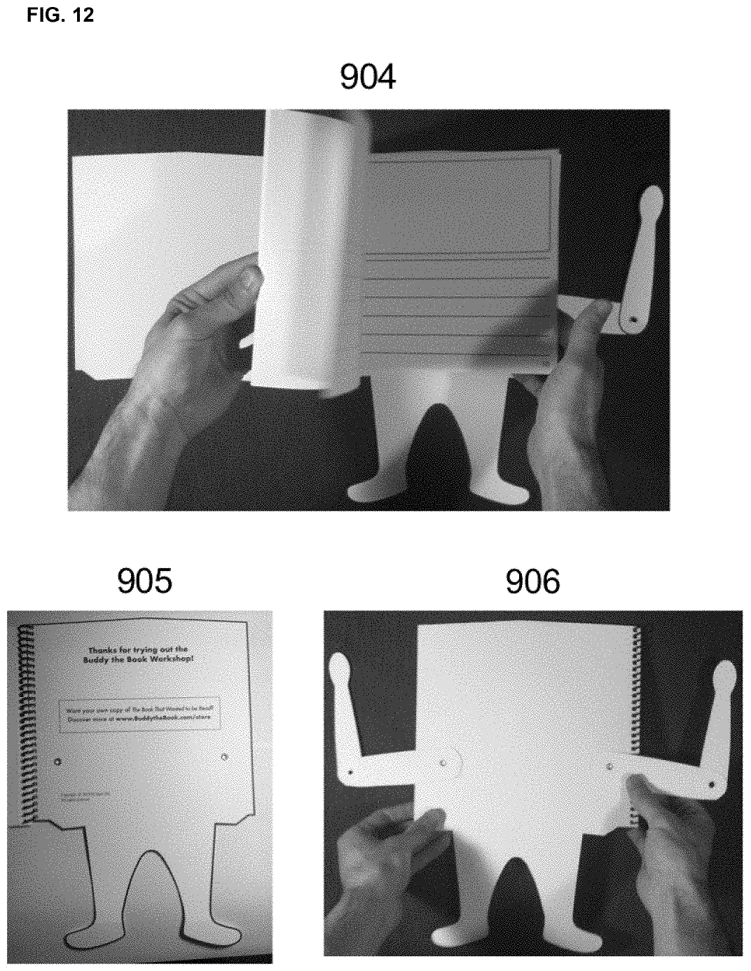

### DESCRIPTION OF PREFERRED EMBODIMENTS

Following is a list of elements corresponding to a particular element referred to herein:
100 book device structure
110 front cover of book device
111 first top surface of front cover of book device
112 first bottom surface of front cover of book device
120 back cover of book device
121 second top surface of back cover of book device
122 second bottom surface of back cover of book device
130 internal page(s)
131 third top surface of internal page(s)
132 third bottom surface of internal page(s)
140 binding component
141 first side
142 opposite side
143 top side
144 bottom side
150 first attachment
151 attachment mechanism such that the first attachment is functional
152 individual components that comprise the first attachment
153 forearm component of the first attachment
154 bicep component of the first attachment
160 second attachment
200 fully designed book characters using a book character device structure
310 coiled binding configuration
320 sewn binding configuration
330 wire binding configuration
340 saddle-stitched binding configuration
350 comb binding configuration
360 tape binding configuration
370 vela binding configuration
380 perfect binding configuration
410 tentacle-shaped first attachment
420 wheel-shaped first attachment
430 wing-shaped first attachment
500 third attachment
510 character features that are not an “arm” or “leg”
610 rotation of first attachment and its components
620 extension of first attachment and its components
630 contraction of first attachment and its components
640 attachment and detachment of first attachment and its components

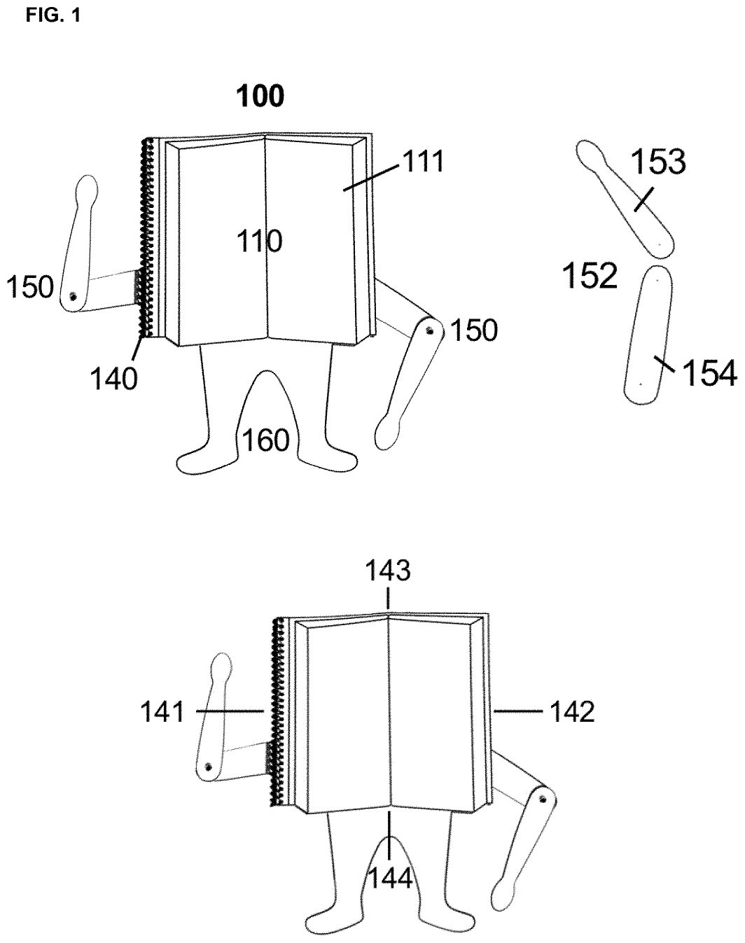

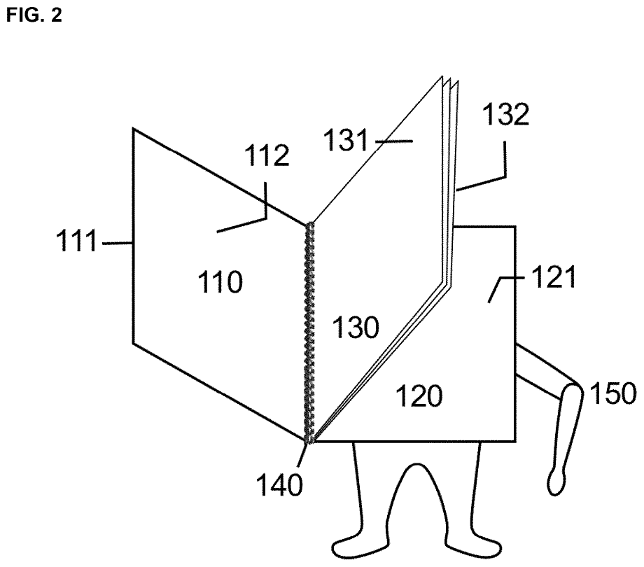

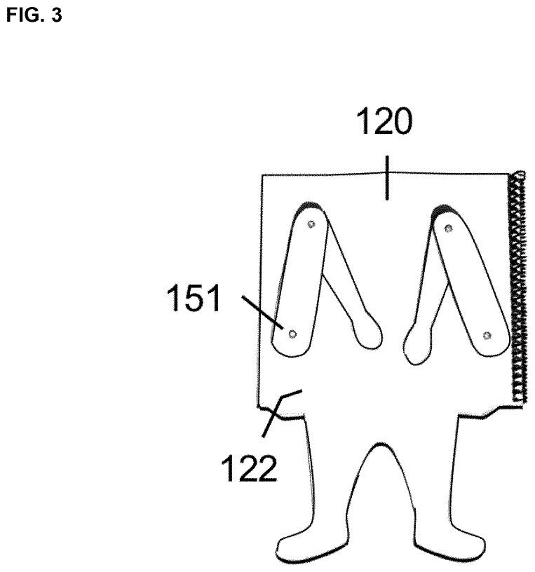

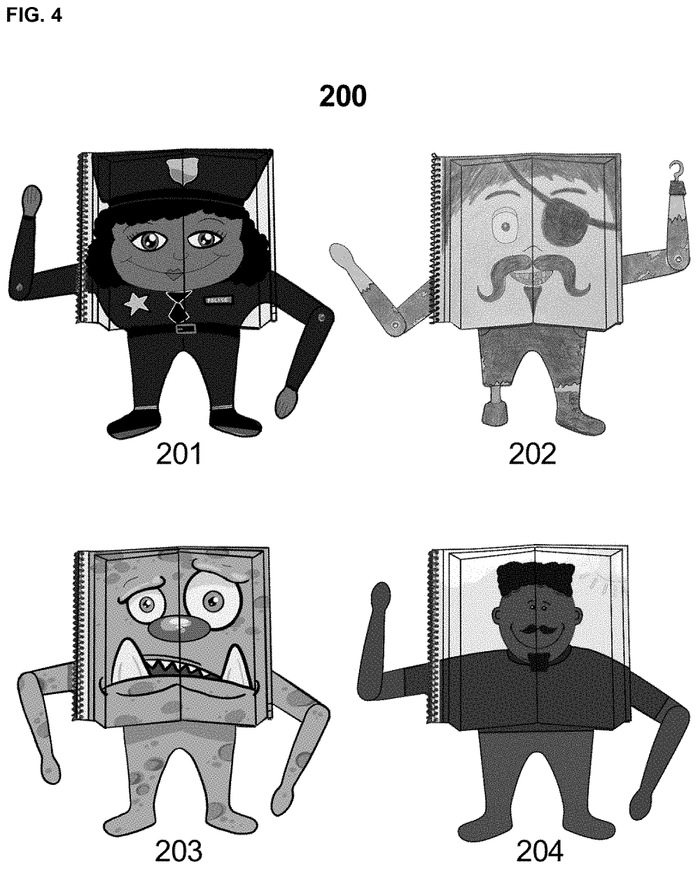

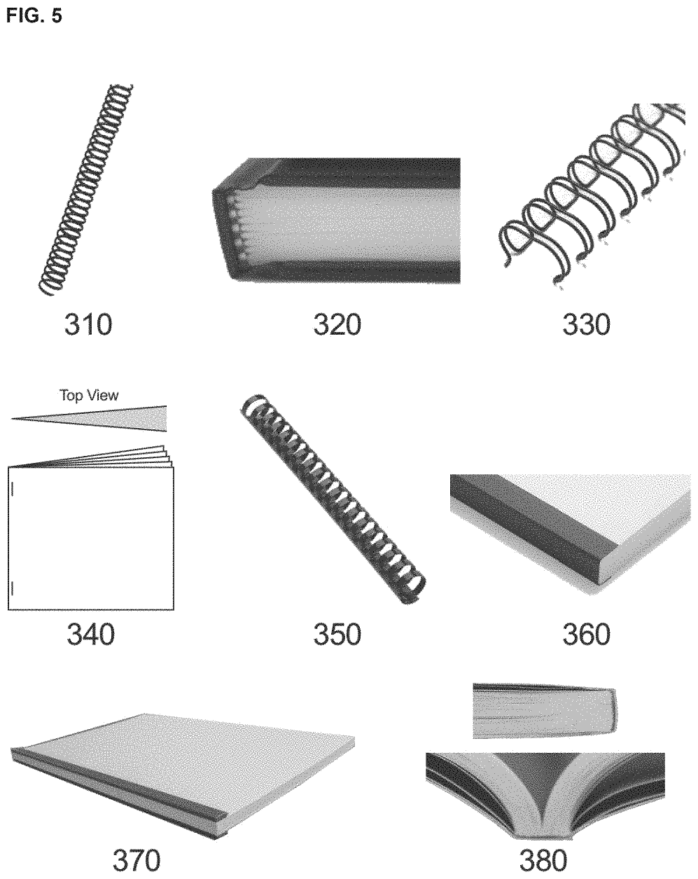

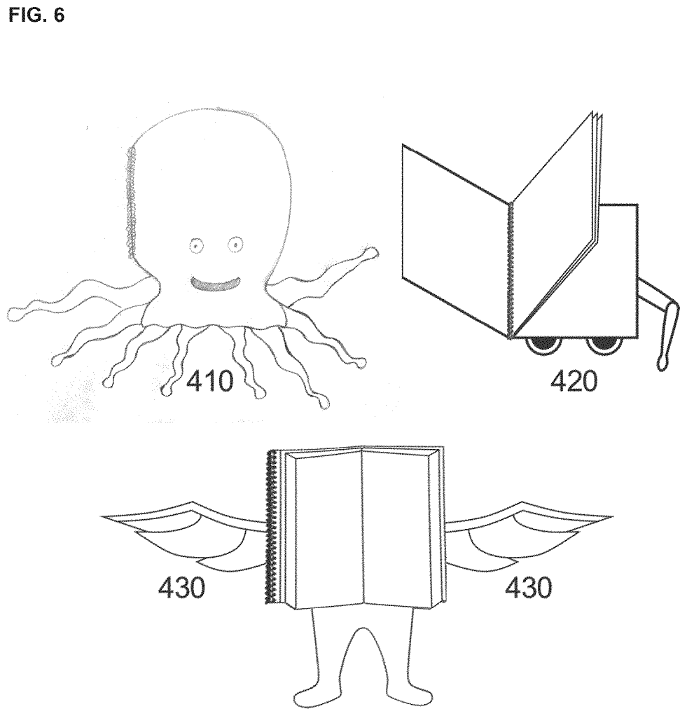

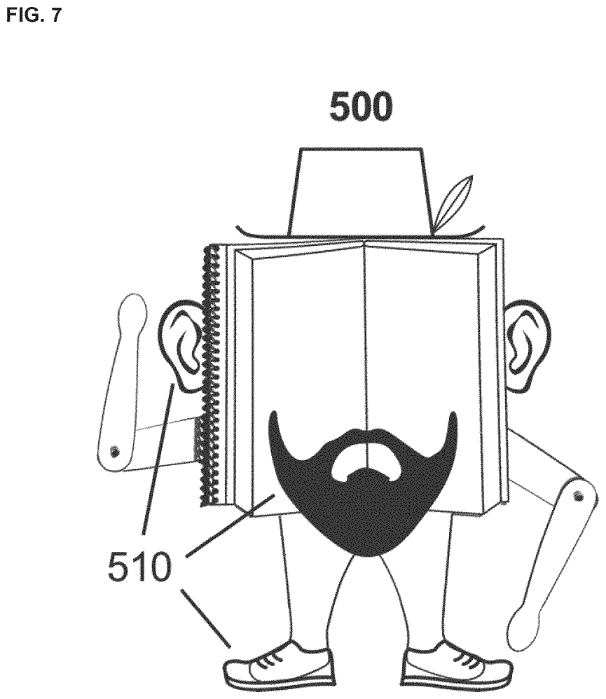

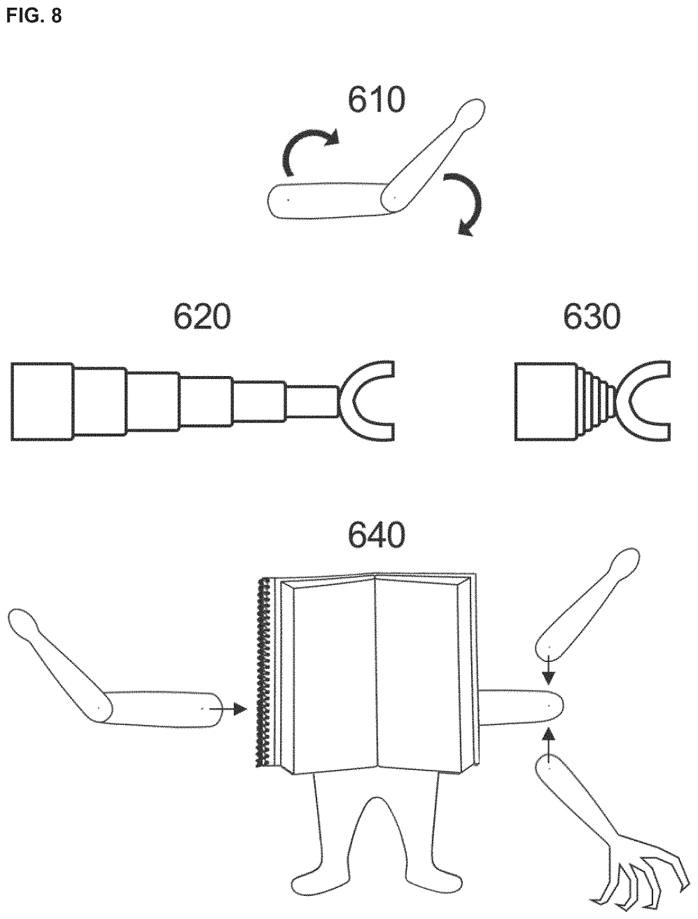

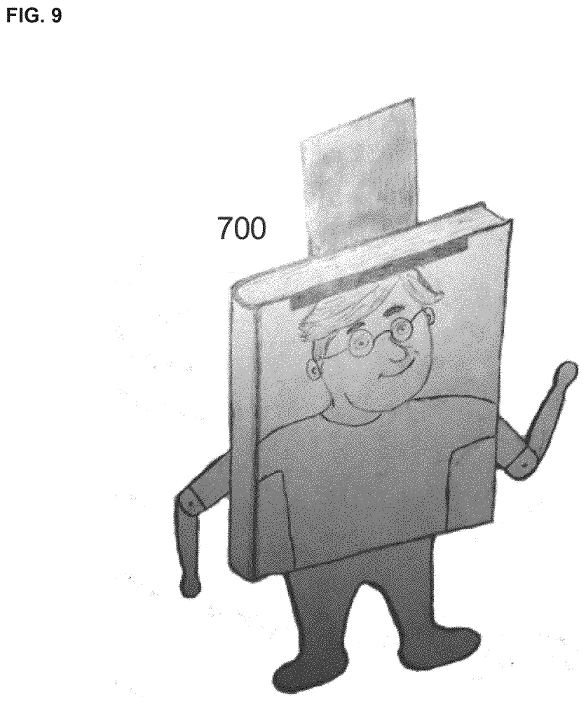

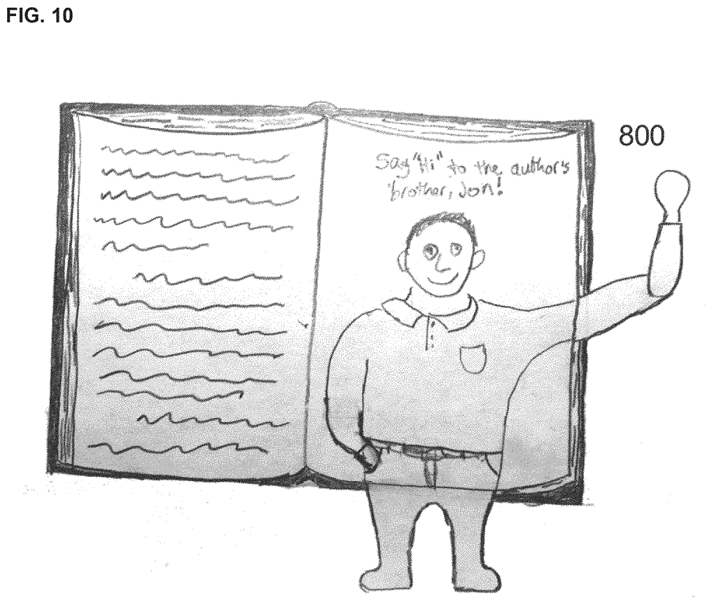

Referring now to FIG. 1-10, the present invention features a book device structure (100) that may be applied to one or a variety of book devices. The front cover (110) is shaped similarly to front covers of book devices. Such book device front covers are well known to one of ordinary skill in the art. For example, the front cover (110) comprises a first top surface (111), a first bottom surface (112) (the surface of the front cover opposite the first top surface). In some embodiments, the shape of the front cover (110) may be adapted to resemble one or more features of a “Book Character”. For example, in one embodiment of the present invention, the front cover (110) may be adapted slightly in its shape such that it reflects an octopus' head, wherein the first attachment (150) is tentacle-shaped (410). In some embodiments, one or more first attachments (150), one or more second attachments (160), and/or one or more third attachments (500) may be combined with or operatively attached to the front cover (110).

The back cover (120) is shaped similarly to back covers of book devices. Such book device back covers are well known to one of ordinary skill in the art. For example, the back cover (120) comprises a second top surface (121), a second bottom surface (122) (the surface of the back cover opposite the second top surface). In some embodiments, the shape of the back cover (120) may be adapted to include one or more features of a “Book Character”. For example, in one embodiment of the present invention, one or more first attachments (150), one or more second attachments (160), and/or one or more third attachments (500) may be combined with or operatively attached to the back cover (120).

One or more internal pages (130) are shaped similarly to internal pages of book devices. Such book device internal pages are well known to one of ordinary skill in the art. For example, an internal page (130) comprises a third top surface (131), a third bottom surface (132) (the surface of the back cover opposite the third top surface). In some embodiments, the shape of one or more internal pages (130) may be adapted to include one or more features of a “Book Character”. For example, in one embodiment of the present invention, one or more first attachments (150), one or more second attachments (160), and/or one or more third attachments (500) may be combined with or operatively attached to one or more internal pages (130).

A binding component (140) is used to combine the front cover (110), back cover (120), and any internal pages (130) into one book device structure (100). The binding component (140) is attached on the first side (141) or the opposite side (142) or the top side (143) or the bottom side (144) of the front cover, back cover, and internal pages such that these components connect into one device. The binding component may be of a coil (310), sewn (320), wire (330), saddle-stitched (340), comb (350), tape (360), velo (370), or perfect (380) binding configuration.

The book device structure (100) comprises at least a first attachment (150) operatively connected (151) to the first top surface (111) or first bottom surface (112) of the front cover (110), or the second top surface (121) or second bottom surface (122) of the back cover (120), or the third top surface (131) or third bottom surface (132) of one or more internal pages (130). The first attachment (150) comprises one or more individual components (152) adapted to function as and resemble the appearance of a leg or arm or a similar feature (410) (420) (430). The first attachment (150) may be engaged with by a user, and the device as a whole resembles a character, individual, or figure, whether real or imagined (200).

The book device structure (100) may or may not comprise one or more second attachments (160) operatively connected (151) or non operatively connected to the first top surface (111) or first bottom surface (112) of the front cover (110), or the second top surface (121) or second bottom surface (122) of the back cover (120), or the third top surface (131) or third bottom surface (132) of one or more internal pages (130). The second attachment (160) comprises one or more individual components (152) adapted to function as and resemble as a leg or arm or a similar feature (410) (420) (430).

The book device structure (100) may or may not comprise one or more third attachments (500) operatively connected (151) or non operatively connected to the first top surface (111) or first bottom surface (112) of the front cover (110), or the second top surface (121) or second bottom surface (122) of the back cover (120), or the third top surface (131) or third bottom surface (132) of one or more internal pages (130). The third attachment (500) comprises one or more individual components (152) adapted to function as and resemble the appearance of an accessory (510), such as apparel, equipment, and other character features.

Depending on the type of attachment, the first attachment (150) may be placed in various particular places on or combined with the front cover (110), back cover (120), and/or one or more internal pages (130). For example, in some embodiments, the attachment is disposed at or near the first top surface (111) of the front cover (110) of the book device structure (100); in some embodiments the attachment is disposed at or near the first bottom surface (112) of the front cover (110); in some embodiments, the attachment is disposed at or near the second top surface (121) of the back cover (120) of the book device structure (100); in some embodiments the attachment is disposed at or near the second bottom surface (122) of the back cover (120); in some embodiments, the attachment is disposed at or near the third top surface (131) of one or more internal pages (130); in some embodiments the attachment is disposed at or near the third bottom surface (132) of one or more internal pages (130).

Depending on the type of attachment, the second attachment (160) may be placed in various particular places on or combined with the front cover (110), back cover (120), and/or one or more internal pages (130). For example, in some embodiments, the attachment is disposed at or near the first top surface (111) of the front cover (110); in some embodiments the attachment is disposed at or near the first bottom surface (112) of the front cover (110); in some embodiments, the attachment is disposed at or near the second top surface (121) of the back cover (120); in some embodiments the attachment is disposed at or near the second bottom surface (122) of the back cover (120); in some embodiments, the attachment is disposed at or near the third top surface (131) of one or more internal pages (130); in some embodiments the attachment is disposed at or near the third bottom surface (132) of one or more internal pages (130).

Depending on the type of attachment, the third attachment (500) may be placed in various particular places on or combined with the front cover (110), back cover (120), and/or one or more internal pages (130). For example, in some embodiments, the attachment is disposed at or near the first top surface (111) of the front cover (110); in some embodiments the attachment is disposed at or near the first bottom surface (112) of the front cover (110); in some embodiments, the attachment is disposed at or near the second top surface (121) of the back cover (120); in some embodiments the attachment is disposed at or near the second bottom surface (122) of the back cover (120); in some embodiments, the attachment is disposed at or near the third top surface (131) of one or more internal pages (130); in some embodiments the attachment is disposed at or near the third bottom surface (132) of one or more internal pages (130).

The first attachment (150) of the book device structure (100) is adapted such that it is functional and may be rotated (610), extended (620), contracted (630), attached and/or detached (640) from the book device structure (100). Furthermore, the first attachment may be composed of one or more components that may attach and detach (640) from each other.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the dimensions of the figures do not limit the claims. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A book device structure (100) comprising:
a front cover (110) comprising a first top surface (111), and a first bottom surface (112) opposite the first top surface; a back cover (120) comprising a second top surface (121), and a second bottom surface (122) opposite the second top surface; one or more internal pages (130) comprising a third top surface (131), and a third bottom surface (132) opposite the third top surface; a binding component (140) used to combine the front cover, back cover, and internal pages into one device, the binding component (140) is attached on the first side (141) or the opposite side (142) or the top (143) or the bottom (144) of the front cover, back cover, and internal pages such that these components connect into one device; one or more first attachments (150) operatively connected (151) to the first top surface (111) or first bottom surface (112) of the front cover (110) or the second top surface (121) or second bottom surface (122) of the back cover (120) or the third top surface (131) or third bottom surface (132) of one or more internal pages (130), the first attachment (150) comprises one or more individual components (152) adapted to function as and resemble a leg or arm, the first attachment is functional and rotatable (610), extendable (620), contractible (630), attachable and detachable (640) from itself and the book device structure (100);
wherein the book device structure (100) collectively resembles a character, individual, or figure, whether real or imagined (200).

2. The book device structure (100) of claim 1, wherein the binding component (140) is that of a coil (310), sewn (320), wire (330), saddle-stitched (340), comb (350), tape (360), velo (370), or perfect (380) binding configuration.

3. The book device structure (100) of claim 1 further comprising one or more second attachments (160) operatively connected (151) or nonoperatively connected to or combined with the first top surface (111) or first bottom surface (112) of the front cover (110) or the second top surface (121) or second bottom surface (122) of the back cover (120) or the third top surface (131) or third bottom surface (132) of one or more internal pages (130), the second attachment (160) comprises one or more individual components adapted to function as and resemble a leg or arm.

4. The book device structure (100) of claim 1 further comprising one or more third attachments (500) operatively connected (151) or nonoperatively connected to or combined with the first top surface (111) or first bottom surface (112) of the front cover (110) or the second top surface (121) or second bottom surface (122) of the back cover (120) or the third top surface (131) or third bottom surface (132) of one or more internal pages (130), the third attachment (500) comprises one or more components adapted to resemble the function and appearance of an accessory (510), apparel, equipment, or other character features.

5. A book device structure (100) comprising:
a) a front cover (110);
b) a back cover (120);
c) one or more internal pages (130);
d) a binding component (140) that binds the front cover, back cover, and the one or more internal pages (130) into a book, wherein the one or more internal pages (130) are disposed between the front cover (110) and the back cover (120); and
e) one or more attachments (150) operatively connected (151) to the front cover (110), the back cover (120), or the one or more internal pages (130), wherein each attachment (150) comprises one or more individual components (152) adapted to function as and resemble an appendage, wherein the book device structure (100) collectively resembles a character, individual, or figure.

6. The book device structure (100) of claim 5, comprising a plurality of the attachments (150), each attachment is removably attached to another attachment or the book.

7. The book device structure (100) of claim 5, wherein the one or more attachments (150) are rotatable, extendable, or collapsible.

8. The book device structure (100) of claim 5, wherein the appendage is a leg, arm, head, tail, fin, wing, branch, or antennae.

10. The book device structure (100) of claim 5, wherein the one or more attachments resemble the function and appearance of an accessory (510), apparel, equipment, or other character features.

11. The book device structure (100) of claim 5, wherein the binding component (140) comprises a coil (310), wire (330), stitching (340), comb (350), tape (360), or hook and loop fasteners (370).
